(19) United States
(12) Patent Application Publication
(10) Pub. No.: US 2026/0186701 A1
(43) Pub. Date: Jul. 2, 2026

(54) DYNAMIC BUFFER ALLOCATION

(71) Applicant: Micron Technology, Inc., Boise, ID (US)

(72) Inventors: Zhanqiang Su, Shanghai (CN); Huachen Li, Shanghai (CN)

(21) Appl. No.: 19/427,975

(22) Filed: Dec. 19, 2025

Related U.S. Application Data
(60) Provisional application No. 63/739,042, filed on Dec. 26, 2024.

(51) Int. Cl. G06F 3/06

(52) U.S. Cl. CPC G06F 3/0656; G06F 3/0604; G06F 3/0673

(57) ABSTRACT

Methods, systems, and devices for dynamic buffer allocation are described. A receiving device may allocate a first portion of a buffer to storing data received from a transmitting device and transmit signaling indicating a first size of the first portion of the buffer. The receiving device may determine whether data stored at the first portion of the buffer satisfies a size threshold and adjust a size of the first portion of the buffer from the first size to a second size in response to determining that the data stored at the first portion satisfies the size threshold. The receiving device may transmit signaling indicating the second size of the first portion of the buffer in response to adjusting the size of the first portion of the buffer.

### CROSS REFERENCE

The present Application for Patent claims priority to U.S. Patent Application No. 63/739,042 by Su et al., entitled “DYNAMIC BUFFER ALLOCATION,” filed Dec. 26, 2024, which is assigned to the assignee hereof, and which is expressly incorporated by reference in its entirety herein.

### TECHNICAL FIELD

The following relates to one or more systems for memory, including dynamic buffer allocation.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports dynamic buffer allocation in accordance with examples as disclosed herein.

FIG. 2 shows an example of a system that supports dynamic buffer allocation in accordance with examples as disclosed herein.

FIG. 3 shows an example of a flow diagram that supports dynamic buffer allocation in accordance with examples as disclosed herein.

FIG. 4 shows an example of a signal timing diagram that supports dynamic buffer allocation in accordance with examples as disclosed herein.

FIG. 5 shows a block diagram of a memory system or a host system that supports dynamic buffer allocation in accordance with examples as disclosed herein.

FIGS. 6 and 7 show flowcharts illustrating a method or methods that support dynamic buffer allocation in accordance with examples as disclosed herein.

### DETAILED DESCRIPTION

Devices (e.g., a host system or a memory system) may include an interface that supports a protocol stack that has multiple layers. In some examples, a device may buffer data at a layer of the protocol stack. For example, a data link layer of the protocol stack of the device may include a receive buffer that stores data received from another device and a transmit buffer that stores data to be transmitted to the other device. The receive buffer and the transmit buffer may occupy a fixed amount of space. Thus, allocating more space to receive buffer may reduce the size of the transmit buffer, and vice versa. To ensure improved utilization of the transmit buffer and the receive buffer, the device may implement a credit system. For example, the device may transmit, to the other device, credits associated with the receive buffer as buffer space in the receive buffer becomes available and the other device may utilize the credits to send data to the device.

In some examples, a total quantity of available credits for the transmit buffer and the receive buffer may be fixed. During operation, the transmit buffer or the receive buffer may be full (or exhausted) resulting in latency. For example, if the receive buffer is full at the device, the other device may wait for new buffer space at the receive buffer before sending more data to the device. However, the receive buffer and the transmit buffer may not be full at the same time. Thus, it may be beneficial for the device to update buffer space allocated to transmit buffer and the receive buffer in response to different operating conditions of the devices.

As described herein, buffer space allocated to the transmit buffer and the receive buffer may change. In some examples, a first device (e.g., a receiving device, a host system, or a memory system) may divide memory for buffers to three portions: a first portion as a receive buffer, a second portion as a transmit buffer, and a third portion as reserved portion. The first device may allocate a first portion of memory to act as a receive buffer of the device to store data received from a second device (e.g., a receiving device, the host system, or the memory system). Upon allocating the first portion, the first device may transmit signaling indicating a first size of the receive buffer to the second device and monitor a data usage of the receive buffer. While monitoring the data usage of the receive buffer, the first device may determine whether data stored at the receiver buffer satisfies a threshold.

If the data stored at the receive buffer satisfies the threshold, the first device may adjust the size of receiver buffer from the first size to a second size and transmit signaling indicating the second size of the receive buffer to the second device. For example, the first device may allocate data from the third portion of memory (e.g., the reserved portion) to the receive buffer based on the size satisfying a threshold. Upon receiving the signaling, the second device may transmit data to the first device in accordance with the second size of the receiver buffer. In some examples, the first device may also perform similar operations with respect to a second portion of the memory to act as a transmit buffer allocated for storing data to be transmitted to the second device. The methods as described herein may allow a device to dynamically change the size of a portion of a buffer (e.g., the first portion or the second portion) in response to current storage needs of the device which may reduce latency.

In addition to applicability in memory systems as described herein, techniques for dynamic buffer allocation may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by creating a more efficient credit control flow between devices which may improve data transfer between devices, enable increased communications between devices, among other benefits.

Features of the disclosure are illustrated and described in the context of systems, devices, and circuits. Features of the disclosure are further illustrated and described in the context of a flow diagram, a signaling timing diagram, and flowcharts.

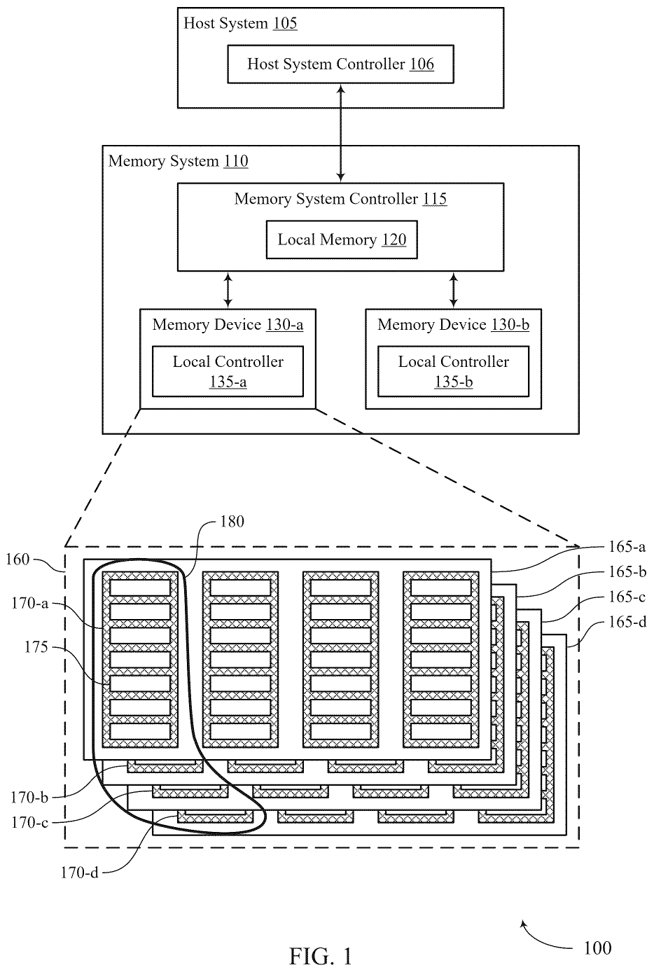

FIG. 1 shows an example of a system 100 that supports dynamic buffer allocation in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0 ” of plane 165-a, block 170-b may be “block 0 ” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples, devices of the system 100 (e.g., the memory system 110 or the host system 105) may support a dynamic buffer allocation. In some examples, a receiving device (the memory system 110 or the host system 105) may allocate a first portion of a buffer as a receive buffer to store data received from a transmitting device (e.g., the memory system 110 or the host system 105), a second portion of the buffer as a transmit buffer to store to send to the other device, and a third portion of the buffer as a reserved portion to be allocated to the receive buffer or the transmit buffer based on operating conditions at the device. The receiving device may transmit, to the transmitting device, signaling indicating a first size of the first portion of the buffer. The receiving device may monitor the data stored at the first portion and determine whether the data stored at the first portion of the buffer satisfies a size threshold.

If the data stored at the first portion of the buffer satisfies the size threshold, the receiving device may adjust the size of the first portion of the buffer from a first size to a second size. For example, the receiving device may allocate space from the third portion of the buffer (e.g., the reserved portion) to the first portion of the buffer (e.g., the receive buffer) to increase the size of the first portion. Further, the receiving device may transmit signaling indicating the second size of the first portion of the buffer. The transmitting device may receive the signaling indicating the second size of the first portion of the buffer and transmit data to the receiving device in accordance with the second size of the first portion of the buffer. Using the methods as described herein may allow devices of the system 100 to more efficiently utilize buffer space resulting in a reduction in latency associated with communication between devices.

The system 100 may include any quantity of non-transitory computer readable media that support dynamic buffer allocation. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

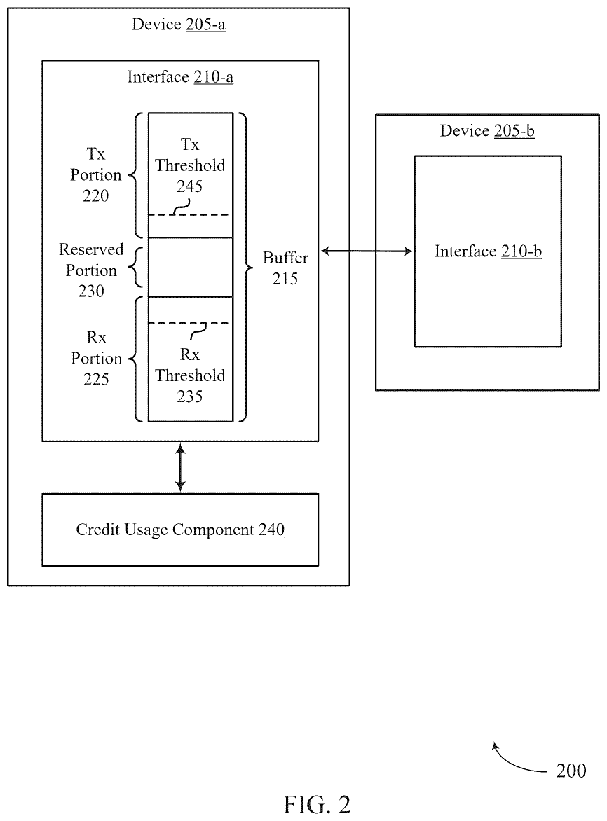

FIG. 2 shows an example of a system 200 that supports dynamic buffer allocation in accordance with examples as disclosed herein. In some examples, the system 200 may implement aspects of a system 100. For example, the system 200 may include a device 205 (e.g., a device 205-a or a device 205-b) which may be an example of a host system 105 or a memory system 110.

As shown in FIG. 2, the system 200 may include the device 205-a and the device 205-b. In some examples, the device 205-a may be an example of a host system and the device 205-b may be an example of a memory system. Alternatively, the device 205-a may be an example of the memory system and the device 205-b may be an example of the host system. In some examples, each device 205 may include a respective interface 210 (e.g., MIPI interface). For example, the device 205-a may include an interface 210-a and the device 205-b may include an interface 210-b. In some examples, each interface 210 may support a protocol stack (e.g., a Unipro Protocol Stack) that includes a set of layers. The set of layers may include one or more of a physical layer (or L1), a data link layer (or L2), a network layer (L3), or a transport layer (L4).

Data that is received or transmitted by the device 205 may travel through the set of layers of the protocol stack. In some examples, if the device receives data, the device 205 may buffer the data at a layer (e.g., L2) of the protocol stack prior to processing the data (e.g., passing the data to the remaining layers of the protocol stack). Additionally or alternatively, if the device transmits data, the device 205 may buffer the data at the layer prior to transmitting the data to another device 205. As such, each of the devices 205 may include a storage component for buffering data. For example, as shown in FIG. 2, the device 205-a may include a buffer 215.

In some examples, the device 205 may divide its respective buffer into multiple different portions. For example, as shown in FIG. 2, the device 205-a may divide the buffer 215 into a transmit portion 220, a receive portion 225, and a reserved portion 230. The device 205-a may allocate the receive portion 225 to store data received from the device 205-b and the transmit portion 220 to store data for transmission to the device 205-b. Alternatively, the device 205-a may not allocate the reserved portion 230 for data storage (at least initially).

In some examples, to ensure proper utilization of the buffers 215, the devices 205 may implement a credit system. For example, the device 205-a may determine an initial size (or an initial credit value) of the receive portion 225, an initial size of the transmit portion 220, and an initial size of the reserved portion 230. In some examples, the initial size of the receive portion 225, the initial size of the transmit portion 220, and the initial size of the reserved portion 230 may be in accordance with a physical memory size configured for the device 205-a.

In some examples, in accordance with the credit system, the device 205-a may transmit signaling to the device 205-b indicating the initial size of the receive portion 225. Upon receiving the signaling indicating the initial size of the receive portion 225, the device 205-b may update a value of first counter stored at the device 205-b (e.g., to reflect the initial size of the receive portion 225). The first counter may indicate a quantity of credits that the device 205-b may utilize to transmit data to the device 205-a . If the device 205-b has pending data to send to the device 205-a , the device 205-b may check the value of the first counter and determine if there is enough credits to send the data to the device 205-b. If there is enough credits to send the data, the device 205-b may transmit the data to the device 205-a and reduce the value of the first counter (e.g., to reflect the reduction in the quantity of credits).

The device 205-a may receive the data from the device 205-b and store the data at the receive portion 225. If the device 205-a processes the data stored at the receive portion 225, the device 205-a may transmit signaling to the device 205-b indicating that buffer space at the receive portion 225 is now available. That is, the device 205-a may transmit signaling indicating a second quantity of credits associated with the receive portion 225. Upon receiving the signaling indicating the quantity of credits, the device 205-b may increase the value of the first counter (e.g., to reflect the addition of the second quantity of credits).

In some examples, one or more similar operations may be implemented for the transmit portion 220 of the device 205-a. For example, upon determining the initial size of the transmit portion 220, the device 205-a may update a value of a second counter stored at the device 205-a (e.g., to reflect the initial size of the transmit portion 220). The value of the second counter may indicate a quantity of credits that the device 205-a may utilize to store data at the transmit portion 220.

If the device 205-a has pending data to send to the device 205-b, the device 205-a may check the value of the second counter and determine if there is enough credits to store the data to the transmit portion 220. If there is enough credits, the device 205-a may store the data at the transmit portion 220 and reduce the value of the second counter (e.g., to reflect the reduction in credits). Further, if the device 205-a transmits the data stored at the transmit portion 220 to the device 205-b, the device 205-a may increase the value of the second counter (e.g., to reflect the addition of the credits). In some examples, the device 205-a and the device 205-b may repeat one or more of these operations during communication with one another.

In some examples, the device 205-a may include a credit usage component 240 that is configured to monitor a credit usage of the buffer 215. During communication with the device 205-b, the credit usage component 240 may determine whether data stored at the receive portion 225 satisfies (e.g., meets or exceeds) a receive threshold 235. In some examples, the receive threshold 235 may be equal to a percentage of the total buffer space allocated to the receive portion 225. For example, the receive threshold 235 may be equal to 90% of the total buffer space allocated to the receive portion 225.

If the data stored at the receive portion 225 satisfies the receive threshold 235, the credit usage component 240 may update the initial size of the receive portion 225 from a first size to a second size. In some examples, updating the initial size of the receive portion 225 from the first size to the second size may include allocating at least some of the reserved portion 230 to store data received from device 205-b. That is, the credit usage component 240 may increase the initial size of the receive portion 225 in response to identifying that the data stored at the receive portion 225 satisfies the receive threshold 235.

Alternatively, if the data stored at the receive portion 225 does not satisfy (e.g., is less than) the receive threshold 235, the credit usage component 240 may maintain the initial size of the receive portion 225 or update the initial size of the receive portion 225 from the first size to a third size. In some examples, updating the initial size of the receive portion 225 from the first size to the third size may include increasing the initial size of the reserved portion 230 to include some of the receive portion 225 thereby decreasing the initial size of the receive portion 225. That is, the credit usage component 240 may maintain or decrease the initial size of the receive portion 225 in response to identifying that the data stored at the receive portion 225 does not satisfy the receive threshold 235.

Similarly, during communication with the device 205-b, the credit usage component 240 may determine whether data stored at the transmit portion 220 satisfies (e.g., meets or exceeds) a transmit threshold 245. In some examples, the transmit threshold 245 may be equal to a percentage of the total buffer space allocated to the transmit portion 220. For example, the transmit threshold 245 may be equal to 90% of the total buffer space allocated to the transmit portion 220.

If the data stored at the transmit portion 220 satisfies the transmit threshold 245, the credit usage component 240 may update the initial size of the transmit portion 220 from a fourth size to a fifth size. In some examples, updating the initial size of the transmit portion 220 from the fourth size to the fifth size may include allocating at least some of the reserved portion 230 to store data to be transmitted to the device 205-b. That is, the credit usage component 240 may increase the initial size of the transmit portion 220 in response to identifying that the data stored at the transmit portion 220 satisfies the transmit threshold 245.

Alternatively, if the data stored at the transmit portion 220 does not satisfy (e.g., is less than) the transmit threshold 245, the credit usage component 240 may maintain the initial size of the transmit portion 220 or update the initial size of the transmit portion 220 from the fourth size to a sixth size. In some examples, updating the initial size of the transmit portion 220 from the fourth size to the sixth size may include increasing the initial size of the reserved portion 230 to include some of the transmit portion 220 thereby decreasing the initial size of the transmit portion 220. That is, the credit usage component 240 may maintain or decrease the initial size of the transmit portion 220 in response to identifying that the data stored at the transmit portion 220 does not satisfy the transmit threshold 245.

Alternatively or additionally, the credit usage component 240 may determine whether data usage of a portion of the buffer reaches the respective threshold frequently or infrequently. For example, the credit usage component 240 may determine whether a quantity of times that the data stored at the receive portion 225 satisfies the receive threshold 235 satisfies (e.g., meets or exceeds) a receive frequency threshold. If the credit usage component 240 determines that the quantity of times that the data stored at the receive portion 225 satisfies the receive threshold 235 satisfies (e.g., meets or exceeds) the receive frequency threshold, the credit usage component 240 may update the initial size of the receive portion 225 from the first size to the second size.

If the credit usage component 240 determines that the quantity of times that the data stored at the receive portion 225 satisfies the receive threshold 235 does not satisfy (e.g., is less than) the receive frequency threshold, the credit usage component 240 may maintain the initial size of the receive portion 225 or update the initial size of the receive portion 225 from the first size to the third size. In some examples, the credit usage component 240 may determine the receive frequency threshold using a performance metric of the device 205-a. In some examples, the credit usage component 240 may apply similar methods to the transmit portion 220. That is, the credit usage component 240 may determine whether a quantity of times that the data stored at the transmit portion 220 satisfies the transmit threshold 245 satisfies (e.g., meets or exceeds) a transmit frequency threshold and adjust or maintain the initial size of the transmit portion 220 accordingly.

In some examples, the credit usage component 240 may update an initial size of a portion of the buffer during some power mode of the device 205-a. For example, the device 205-a may enter a hibernation status and, while operating according to the hibernation status, the credit usage component 240 may update the initial size of the receive portion 225 (e.g., from the first size to the second size or the third size) or the initial size of the transmit portion 220 (e.g., from the fourth size to the fifth size or the sixth size). Upon exiting the hibernation mode, the device 205-a may transmit signaling to the device 205-b indicating the updated initial size of the receive portion 225 (e.g., the second size or the third size) or the initial size of the transmit portion 220 (e.g., the fifth size or the sixth size). Using the methods as described herein may allow devices to more efficiently utilize buffer storage compared to other methods resulting in a decrease in latency for communications between the devices.

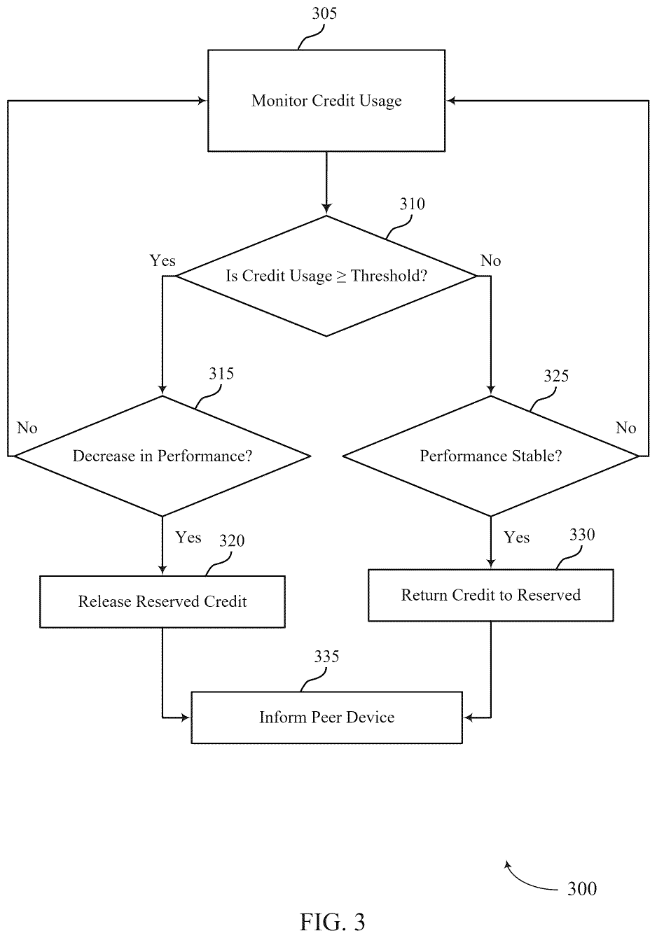

FIG. 3 shows an example of a flow diagram 300 that supports dynamic buffer allocation in accordance with examples as disclosed herein. In some examples, the flow diagram 300 may be performed by aspects of the system 100 and the system 200. For example, the flow diagram 300 may be performed by the memory system 110, the host system 105, or the device 205.

As described in FIG. 2, a device may include a buffer for storing data at a layer (e.g., L2) of a protocol stack (e.g., a Unipro protocol stack) supported by the device. In some examples, the device may divide the buffer into different portions that include a receive portion, a transmit portion, and a reserved portion. The receive portion may store data received from another device, the transmit portion may store data to be transmitted to the other device, and the reserved portion may not be allocated for data storage. In some examples, prior to 305, the device may determine an initial size for the transmit portion, an initial size for the receive portion, and an initial size for the receive portion. An initial size of the portion of the buffer may refer to a total amount of buffer space that the portion of the buffer occupies within the buffer.

At 305, credit usage associated with a portion of the buffer may be monitored. For example, the device may monitor an amount of data stored at a portion of the buffer (e.g., the transmit portion or the receive portion).

At 310, it may be determined whether the credit usage associated with the portion of the buffer satisfies a first size threshold. For example, the device may determine whether the amount of data stored at the portion of the buffer satisfies (e.g., exceeds or meets) a first size threshold. If the amount of data stored at the portion of the buffer exceeds the first size threshold, the device may proceed to 315. If the amount of data stored at the portion of the buffer does not exceed the first size threshold, the device may proceed to 325.

At 315, it may be determined whether there is decrease in a performance of the device. A decrease in performance may include an increase in latency in communication between the devices. In some examples, the device may determine there is a decrease in the performance if the credit usage associated with the portion satisfies the first size threshold frequently or in other word, if the device determines that a quantity of times that the data stored at the portion of the buffer satisfies the first size threshold satisfies (e.g., exceeds or meets) a first frequency threshold within a duration. If there is no decrease in the performance of the device, the device may proceed to 305 and continue to monitor the credit usage. Alternatively, if there is a decrease in the performance of the device, the device may proceed to 320.

At 320, some credit from the reserved portion may be released. For example, the device may update the initial size of the portion of the buffer from a first size to a second size. In some examples, updating the initial size of the buffer may include allocating at least some of reserved portion to storing the same type of data stored by the portion of the buffer thereby increasing the initial size of the portion of the buffer. In some examples, the device may update the initial size of the portion of the buffer while the device is in a hibernate mode.

At 325, it may be determined whether the performance of the device is stable (e.g., the performance of the device does not fluctuate a threshold amount). In some examples, the device may determine that the performance of the device is stable (e.g., stable at a low level) if the credit usage associated with the portion does not satisfy the first size threshold within a duration (or satisfies the first size threshold infrequently or not at all). In such case, the device may proceed to 330. Alternatively, if the performance of the device is not stable, the device may proceed to 305 and continue to monitor the credit usage.

At 330, some credit (e.g., credit previously allocated for the transmit portion or the receive portion) may be returned to the reserved portion. For example, the device may update the initial size of the portion of the buffer from the first size to a third size. In some examples, updating the initial size of the portion of the buffer from the first size to third size may include deactivating a storage capability of some of the portion of the buffer thereby increasing the initial size of the reserved portion and decreasing the initial size of the portion of the buffer. In some examples, the device may update the initial size of the portion of the buffer while the device is in the hibernate mode.

At 335, a peer device may be informed of the updated initial size of the portion of the buffer. For example, the device may transmit signaling to the peer device indicating the updated initial size of the portion of the buffer. In some examples, the device may transmit the signaling indicating the updated initial size of the portion of the buffer upon exiting the hibernate mode.

In some examples, the first size threshold at 310 may be dynamic. That is, the value of the first size threshold may change in response to a change in the initial size of the portion of the buffer. For example, if the initial size of the portion of the buffer decreases, the threshold may also decrease. Alternatively, if the initial size of the portion of the buffer increases, the threshold may also increase. Using the methods as described herein may decrease latency associated with communication between devices, among other advantages.

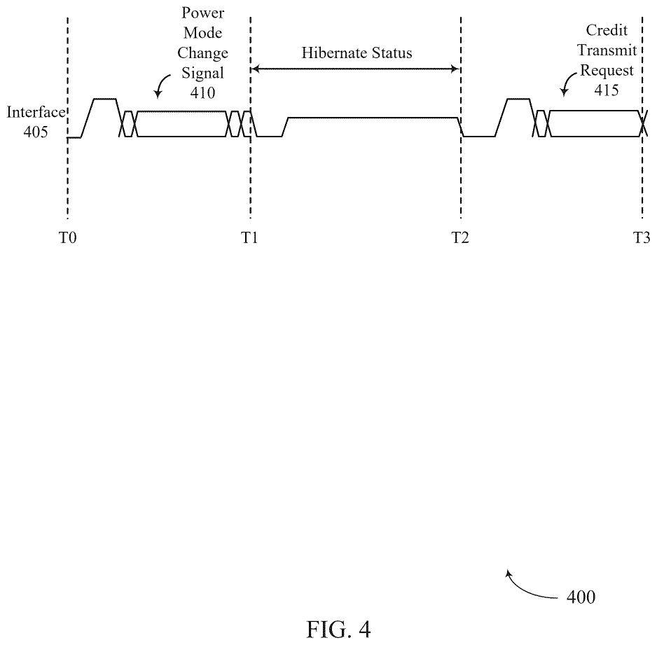

FIG. 4 shows an example of a signal timing diagram 400 that supports dynamic buffer allocation in accordance with examples as disclosed herein. In some examples, the signal timing diagram 400 may be implemented by aspects of the system 100 or the system 200. For example, the signal timing diagram 400 may be implemented by the memory system 110, the host system 105, or the device 205 as described with reference to FIG. 1 and FIG. 2.

As described with reference to FIG. 2, a device may include buffer that stores data at a layer of a protocol stack (e.g., Unipro protocol stack) supported by the device. In some examples, the device may divide the buffer into multiple portions that include a transmit portion, a reserved portion, and a receive portion. Further, the device may monitor a data usage of the receive portion of the buffer and determine whether the data usage of the receive portion of the buffer satisfies a threshold. If the data usage of the receive portion of the buffer satisfies the threshold, the device may update a size of the receive portion of the buffer from a first size to a second size and transmit signaling to another device indicating the updated size of the receive portion of the buffer.

In some examples, an interface 405 (e.g., MIPI interface) of the device that supports the protocol stack may periodically enter a hibernation state to conserve power. From T0 to T1, the device may receive a power mode change signal 410 from the other device. If the device includes a peer device, the power mode change signal 410 may include a PACP_PWR_req. If the device includes a local device, the power mode change signal 410 may include a PACP_PWR_cnf. In some examples, the power mode change signal 410 may trigger the interface 405 of the device to enter the hibernation status. Thus, the interface 405 of the device may enter the hibernation state at T1 and remain in the hibernation state until T2. In some examples, while the interface 405 is in the hibernation state, the device may update the size of the portion of the receive buffer from the first size to the second size. At T2, the interface 405 may exit the hibernation status.

From T2 to T3, the device may receive a credit transmit request 415 (e.g., AFC1/AFC2) from the other device. In some examples, a value of the credit transmit request 415 may be set to a value (e.g., one) that indicates for the device to transmit the updated size of the receive portion of the device to the other device. In response to receiving the credit transmit request 415, the device may transmit the updated size of the receive portion of the buffer to the other device. In some examples, upon receiving the updated size of the receive portion of the device, the other device may transmit data to the device in accordance with the updated size. Using these methods, latency associated with communication between devices may be reduced when compared to other methods.

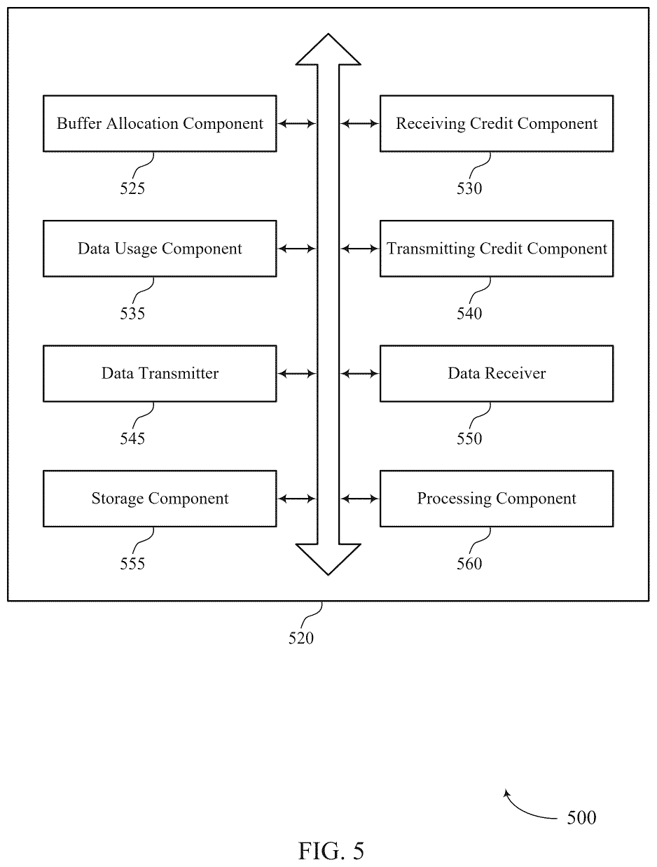

FIG. 5 shows a block diagram 500 of a device 520 that supports dynamic buffer allocation in accordance with examples as disclosed herein. The device 520 may be an example of a receiving device or a transmitting device. A receiving device may be an example of aspects of a memory system or a host system as described with reference to FIGS. 1 through 4. A transmitting device may be an example of aspects of a memory system or a host system as described with reference to FIGS. 1 through 4. The device 520, or various components thereof, may be an example of means for performing various aspects of dynamic buffer allocation as described herein. For example, the device 520 may include a buffer allocation component 525, a receiving credit component 530, a data usage component 535, a transmitting credit component 540, a data transmitter 545, a data receiver 550, a storage component 555, a processing component 560, or any combination thereof. Each of these components, or components of subcomponents thereof (e.g., one or more processors, one or more memories), may communicate, directly or indirectly, with one another (e.g., via one or more buses).

The buffer allocation component 525 may be configured as or otherwise support a means for allocating a first portion of a buffer to storing data received from a transmitting device. The receiving credit component 530 may be configured as or otherwise support a means for transmitting, to the transmitting device, signaling indicating a first size of the first portion of the buffer. The data usage component 535 may be configured as or otherwise support a means for determining whether data stored at the first portion of the buffer satisfies a size threshold. In some examples, the buffer allocation component 525 may be configured as or otherwise support a means for adjusting a size of the first portion of the buffer from the first size to a second size in response to determining that the data stored at the first portion satisfies the size threshold. In some examples, the receiving credit component 530 may be configured as or otherwise support a means for transmitting, to the transmitting device, signaling indicating the second size of the first portion of the buffer in response to adjusting the size of the first portion of the buffer.

In some examples, the buffer allocation component 525 may be configured as or otherwise support a means for allocating a second portion of the buffer to storing data to be transmitted to the transmitting device.

In some examples, the data usage component 535 may be configured as or otherwise support a means for determining whether data stored at the second portion of the buffer satisfies a second size threshold. In some examples, the buffer allocation component 525 may be configured as or otherwise support a means for adjusting the size of the second portion of the buffer from a third size to a fourth size in response to determining that the data stored at the second portion satisfies the second size threshold. In some examples, the buffer includes a third portion that is non-overlapping with the first portion and the second portion.

In some examples, to support adjusting the size of the first portion, the buffer allocation component 525 may be configured as or otherwise support a means for allocating at least some of the third portion of the buffer to storing the data received from the transmitting device.

In some examples, the data receiver 550 may be configured as or otherwise support a means for receiving, from the transmitting device and after transmitting the signaling indicating the second size of the first portion of the buffer, first data for storage at the first portion of the buffer. In some examples, the storage component 555 may be configured as or otherwise support a means for storing, at the first portion of the buffer, the first data in response to receiving the first data. In some examples, the processing component 560 may be configured as or otherwise support a means for processing the first data in response to storing the first data. In some examples, the receiving credit component 530 may be configured as or otherwise support a means for transmitting, to the transmitting device, signaling indicating that buffer space is available at the first portion in response to processing the first data and in accordance with the second size of the first portion of the buffer. In some examples, the data receiver 550 may be configured as or otherwise support a means for receiving, from the transmitting device, second data for storage at the first portion of the buffer in response to transmitting the signaling indicating that the buffer space is available at the first portion.

In some examples, the data usage component 535 may be configured as or otherwise support a means for determining, after adjusting the size of the first portion of the buffer, that the data stored at the first portion of the buffer is below a second size threshold. In some examples, the buffer allocation component 525 may be configured as or otherwise support a means for decreasing the size of the first portion of the buffer from the second size to a third size in response to determining that the data stored at the first portion is below the second size threshold. In some examples, the receiving credit component 530 may be configured as or otherwise support a means for transmitting, to the transmitting device, signaling indicating the third size of the first portion of the buffer in response to decreasing the size of the first portion of the buffer.

In some examples, the data usage component 535 may be configured as or otherwise support a means for determining that a quantity of times that the data stored at the first portion of the buffer satisfies the size threshold satisfies a second size threshold, where adjusting the size of the first portion of the buffer is in response to determining that the quantity of times that the data stored at the first portion satisfies the size threshold satisfies the second size threshold.

In some examples, the second size threshold is in accordance with a performance metric of the receiving device. In some examples, updating the size of the first portion of the buffer occurs during a hibernate operation. In some examples, transmitting the signaling indicating the second size of the first portion of the buffer occurs during or after a hibernate operation.

The transmitting credit component 540 may be configured as or otherwise support a means for receiving, from a receiving device, signaling indicating a first size of a first portion of a buffer, the first portion of the buffer allocated for storing data received at the receiving device from the transmitting device. The data transmitter 545 may be configured as or otherwise support a means for transmitting, to the receiving device, first data for storage at the first portion of the buffer in accordance with the first size of the first portion. In some examples, the transmitting credit component 540 may be configured as or otherwise support a means for receiving, from the receiving device, signaling indicating a second size of the first portion of the buffer different than the first size of the first portion of the buffer. In some examples, the data transmitter 545 may be configured as or otherwise support a means for transmitting, to the receiving device, second data for storage at the first portion of the buffer in accordance with the second size of the first portion.

In some examples, the transmitting credit component 540 may be configured as or otherwise support a means for receiving, from the receiving device and after transmitting the second data for storage at the first portion of the buffer, signaling indicating that buffer space is available at the first portion of the buffer in accordance with the second size of the first portion of the buffer.

In some examples, the data transmitter 545 may be configured as or otherwise support a means for transmitting, to the receiving device, third data for storage at the first portion of the buffer in response to receiving the signaling indicating that the buffer space is available at the first portion of the buffer.

In some examples, the first size of the first portion of the buffer is smaller than the second size of the first portion of the buffer. In some examples, the first size of the first portion of the buffer is larger than the second size of the first portion of the buffer. In some examples, receiving the signaling indicating the second size of the first portion of the buffer occurs during or after a hibernate operation.

In some examples, the described functionality of the device 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the device 520, or various components thereof, may be implemented at least in part by instructions (e.g., stored in memory, non-transitory computer-readable medium) executable by such at least one processor.

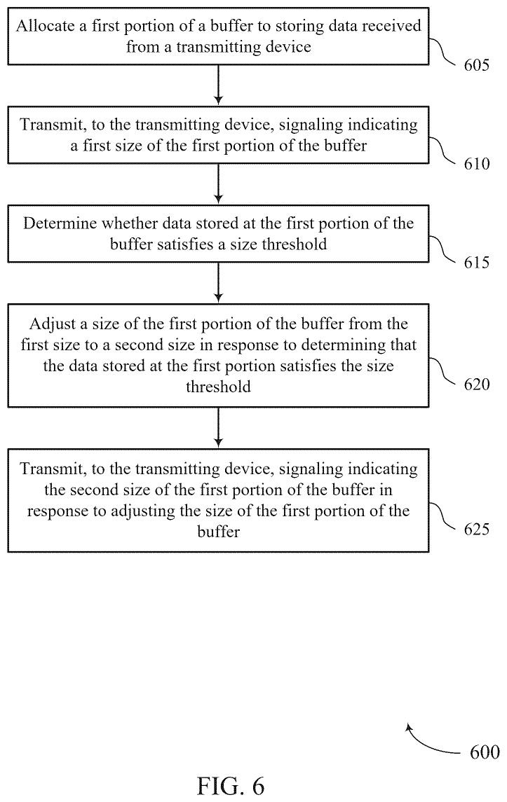

FIG. 6 shows a flowchart illustrating a method 600 that supports dynamic buffer allocation in accordance with examples as disclosed herein. The operations of method 600 may be implemented by a receiving device. The receiving device may be an example of aspects of a memory system or a host system as described herein. For example, the operations of method 600 may be performed by a memory system or a host system as described with reference to FIGS. 1 through 5. In some examples, a receiving device may execute a set of instructions to control the functional elements of the device to perform the described functions. Additionally, or alternatively, the receiving device may perform aspects of the described functions using special-purpose hardware.

At 605, the method may include allocating a first portion of a buffer to storing data received from a transmitting device. In some examples, aspects of the operations of 605 may be performed by a buffer allocation component 525 as described with reference to FIG. 5.

At 610, the method may include transmitting, to the transmitting device, signaling indicating a first size of the first portion of the buffer. In some examples, aspects of the operations of 610 may be performed by a receiving credit component 530 as described with reference to FIG. 5.

At 615, the method may include determining whether data stored at the first portion of the buffer satisfies a size threshold. In some examples, aspects of the operations of 615 may be performed by a data usage component 535 as described with reference to FIG. 5.

At 620, the method may include adjusting a size of the first portion of the buffer from the first size to a second size in response to determining that the data stored at the first portion satisfies the size threshold. In some examples, aspects of the operations of 620 may be performed by a buffer allocation component 525 as described with reference to FIG. 5.

At 625, the method may include transmitting, to the transmitting device, signaling indicating the second size of the first portion of the buffer in response to adjusting the size of the first portion of the buffer. In some examples, aspects of the operations of 625 may be performed by a receiving credit component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for allocating a first portion of a buffer to storing data received from a transmitting device; transmitting, to the transmitting device, signaling indicating a first size of the first portion of the buffer; determining whether data stored at the first portion of the buffer satisfies a size threshold; adjusting a size of the first portion of the buffer from the first size to a second size in response to determining that the data stored at the first portion satisfies the size threshold; and transmitting, to the transmitting device, signaling indicating the second size of the first portion of the buffer in response to adjusting the size of the first portion of the buffer.

Aspect 2: The method, apparatus, or non-transitory computer-readable medium of aspect 1, further including operations, features, circuitry, logic, means, or instructions, or any combination thereof for allocating a second portion of the buffer to storing data to be transmitted to the transmitting device.

Aspect 3: The method, apparatus, or non-transitory computer-readable medium of aspect 2, further including operations, features, circuitry, logic, means, or instructions, or any combination thereof for determining whether data stored at the second portion of the buffer satisfies a second size threshold and adjusting the size of the second portion of the buffer from a third size to a fourth size in response to determining that the data stored at the second portion satisfies the second size threshold.

Aspect 4: The method, apparatus, or non-transitory computer-readable medium of any of aspects 2 through 3, where the buffer includes a third portion that is non-overlapping with the first portion and the second portion.

Aspect 5: The method, apparatus, or non-transitory computer-readable medium of aspect 4, where adjusting the size of the first portion includes operations, features, circuitry, logic, means, or instructions, or any combination thereof for allocating at least some of the third portion of the buffer to storing the data received from the transmitting device.

Aspect 6: The method, apparatus, or non-transitory computer-readable medium of any of aspects 1 through 5, further including operations, features, circuitry, logic, means, or instructions, or any combination thereof for receiving, from the transmitting device and after transmitting the signaling indicating the second size of the first portion of the buffer, first data for storage at the first portion of the buffer; storing, at the first portion of the buffer, the first data in response to receiving the first data; processing the first data in response to storing the first data; transmitting, to the transmitting device, signaling indicating that buffer space is available at the first portion in response to processing the first data and in accordance with the second size of the first portion of the buffer; and receiving, from the transmitting device, second data for storage at the first portion of the buffer in response to transmitting the signaling indicating that the buffer space is available at the first portion.

Aspect 7: The method, apparatus, or non-transitory computer-readable medium of any of aspects 1 through 6, further including operations, features, circuitry, logic, means, or instructions, or any combination thereof for determining, after adjusting the size of the first portion of the buffer, that the data stored at the first portion of the buffer is below a second size threshold; decreasing the size of the first portion of the buffer from the second size to a third size in response to determining that the data stored at the first portion is below the second size threshold; and transmitting, to the transmitting device, signaling indicating the third size of the first portion of the buffer in response to decreasing the size of the first portion of the buffer.

Aspect 8: The method, apparatus, or non-transitory computer-readable medium of any of aspects 1 through 7, further including operations, features, circuitry, logic, means, or instructions, or any combination thereof for determining that a quantity of times that the data stored at the first portion of the buffer satisfies the size threshold satisfies a second size threshold, where adjusting the size of the first portion of the buffer is in response to determining that the quantity of times that the data stored at the first portion satisfies the size threshold satisfies the second size threshold.

Aspect 9: The method, apparatus, or non-transitory computer-readable medium of aspect 8, where the second size threshold is in accordance with a performance metric of the receiving device.

Aspect 10: The method, apparatus, or non-transitory computer-readable medium of any of aspects 1 through 9, where updating the size of the first portion of the buffer occurs during a hibernate operation.

Aspect 11: The method, apparatus, or non-transitory computer-readable medium of any of aspects 1 through 10, where transmitting the signaling indicating the second size of the first portion of the buffer occurs during or after a hibernate operation.

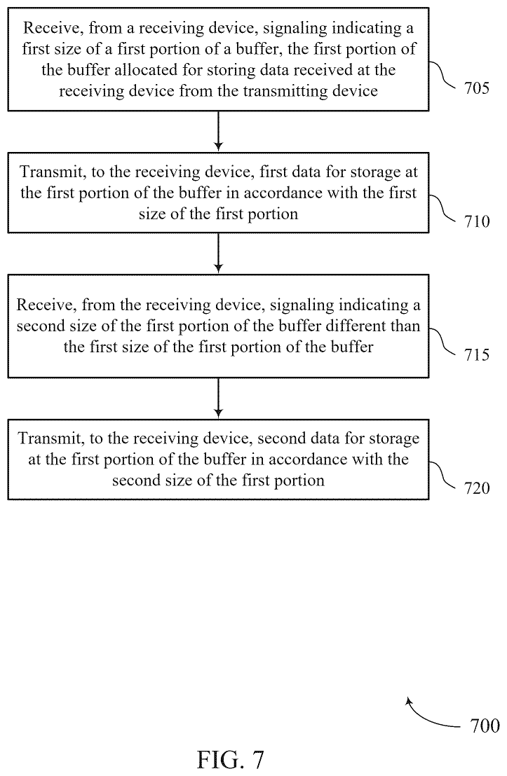

FIG. 7 shows a flowchart illustrating a method 700 that supports dynamic buffer allocation in accordance with examples as disclosed herein. The operations of method 700 may be implemented by a transmitting device. The transmitting device may be an example of aspects of a memory system or a host system as described herein. For example, the operations of method 700 may be performed by a memory system or a host system as described with reference to FIGS. 1 through 5. In some examples, a transmitting device may execute a set of instructions to control the functional elements of the device to perform the described functions. Additionally, or alternatively, the transmitting device may perform aspects of the described functions using special-purpose hardware.

At 705, the method may include receiving, from a receiving device, signaling indicating a first size of a first portion of a buffer, the first portion of the buffer allocated for storing data received at the receiving device from the transmitting device. In some examples, aspects of the operations of 705 may be performed by a transmitting credit component 540 as described with reference to FIG. 5.

At 710, the method may include transmitting, to the receiving device, first data for storage at the first portion of the buffer in accordance with the first size of the first portion. In some examples, aspects of the operations of 710 may be performed by a data transmitter 545 as described with reference to FIG. 5.

At 715, the method may include receiving, from the receiving device, signaling indicating a second size of the first portion of the buffer different than the first size of the first portion of the buffer. In some examples, aspects of the operations of 715 may be performed by a transmitting credit component 540 as described with reference to FIG. 5.

At 720, the method may include transmitting, to the receiving device, second data for storage at the first portion of the buffer in accordance with the second size of the first portion. In some examples, aspects of the operations of 720 may be performed by a data transmitter 545 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for receiving, from a receiving device, signaling indicating a first size of a first portion of a buffer, the first portion of the buffer allocated for storing data received at the receiving device from the transmitting device; transmitting, to the receiving device, first data for storage at the first portion of the buffer in accordance with the first size of the first portion; receiving, from the receiving device, signaling indicating a second size of the first portion of the buffer different than the first size of the first portion of the buffer; and transmitting, to the receiving device, second data for storage at the first portion of the buffer in accordance with the second size of the first portion.

Aspect 13: The method, apparatus, or non-transitory computer-readable medium of aspect 12, further including operations, features, circuitry, logic, means, or instructions, or any combination thereof for receiving, from the receiving device and after transmitting the second data for storage at the first portion of the buffer, signaling indicating that buffer space is available at the first portion of the buffer in accordance with the second size of the first portion of the buffer.

Aspect 14: The method, apparatus, or non-transitory computer-readable medium of aspect 13, further including operations, features, circuitry, logic, means, or instructions, or any combination thereof for transmitting, to the receiving device, third data for storage at the first portion of the buffer in response to receiving the signaling indicating that the buffer space is available at the first portion of the buffer.

Aspect 15: The method, apparatus, or non-transitory computer-readable medium of any of aspects 12 through 14, where the first size of the first portion of the buffer is smaller than the second size of the first portion of the buffer.

Aspect 16: The method, apparatus, or non-transitory computer-readable medium of any of aspects 12 through 15, where the first size of the first portion of the buffer is larger than the second size of the first portion of the buffer.

Aspect 17: The method, apparatus, or non-transitory computer-readable medium of any of aspects 12 through 16, where receiving the signaling indicating the second size of the first portion of the buffer occurs during or after a hibernate operation.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A receiving device, comprising:
processing circuitry configured to cause the receiving device to:
allocate a first portion of a buffer to storing data received from a transmitting device;
transmit signaling indicating a first size of the first portion of the buffer;
determine whether data stored at the first portion of the buffer satisfies a size threshold;
adjust a size of the first portion of the buffer from the first size to a second size in response to determining that the data stored at the first portion satisfies the size threshold; and
transmit signaling indicating the second size of the first portion of the buffer in response to adjusting the size of the first portion of the buffer.

2. The receiving device of claim 1, wherein the processing circuitry is further configured to cause the receiving device to:
allocate a second portion of the buffer to storing data to be transmitted to the transmitting device.

3. The receiving device of claim 2, wherein the processing circuitry is further configured to cause the receiving device to:
determine whether data stored at the second portion of the buffer satisfies a second size threshold; and
adjust the size of the second portion of the buffer from a third size to a fourth size in response to determining that the data stored at the second portion satisfies the second size threshold.

4. The receiving device of claim 2, wherein the buffer comprises a third portion that is non-overlapping with the first portion and the second portion.

5. The receiving device of claim 4, wherein, to adjust the size of the first portion, wherein the processing circuitry is configured to cause the receiving device to:
allocate at least some of the third portion of the buffer to storing the data received from the transmitting device.

6. The receiving device of claim 1, wherein the processing circuitry is further configured to cause the receiving device to:
receive, after transmitting the signaling indicating the second size of the first portion of the buffer, first data for storage at the first portion of the buffer;
store, at the first portion of the buffer, the first data in response to receiving the first data;
process the first data in response to storing the first data;
transmit signaling indicating that buffer space is available at the first portion in response to processing the first data and in accordance with the second size of the first portion of the buffer; and
receive second data for storage at the first portion of the buffer in response to transmitting the signaling indicating that the buffer space is available at the first portion.

7. The receiving device of claim 1, wherein the processing circuitry is further configured to cause the receiving device to:
determine, after adjusting the size of the first portion of the buffer, that the data stored at the first portion of the buffer is below a second size threshold;
decrease the size of the first portion of the buffer from the second size to a third size in response to determining that the data stored at the first portion is below the second size threshold; and
transmit signaling indicating the third size of the first portion of the buffer in response to decreasing the size of the first portion of the buffer.

8. The receiving device of claim 1, wherein the processing circuitry is further configured to cause the receiving device to:
determine that a quantity of times that the data stored at the first portion of the buffer satisfies the size threshold satisfies a second size threshold, wherein adjusting the size of the first portion of the buffer is in response to determining that the quantity of times that the data stored at the first portion satisfies the size threshold satisfies the second size threshold.

9. The receiving device of claim 8, wherein the second size threshold is in accordance with a performance metric of the receiving device.

10. The receiving device of claim 1, wherein updating the size of the first portion of the buffer occurs during a hibernate operation.

11. The receiving device of claim 1, wherein transmitting the signaling indicating the second size of the first portion of the buffer occurs during or after a hibernate operation.

12. A transmitting device, comprising:
processing circuitry configured to cause the transmitting device to:
receive signaling indicating a first size of a first portion of a buffer, the first portion of the buffer allocated for storing data received at a receiving device from the transmitting device;
transmit first data for storage at the first portion of the buffer in accordance with the first size of the first portion;
receive signaling indicating a second size of the first portion of the buffer different than the first size of the first portion of the buffer; and
transmit second data for storage at the first portion of the buffer in accordance with the second size of the first portion.

13. The transmitting device of claim 12, wherein the processing circuitry is further configured to cause the transmitting device to:
receive, after transmitting the second data for storage at the first portion of the buffer, signaling indicating that buffer space is available at the first portion of the buffer in accordance with the second size of the first portion of the buffer.

14. The transmitting device of claim 13, wherein the processing circuitry is further configured to cause the transmitting device to:
transmit third data for storage at the first portion of the buffer in response to receiving the signaling indicating that the buffer space is available at the first portion of the buffer.

15. The transmitting device of claim 12, wherein the first size of the first portion of the buffer is smaller than the second size of the first portion of the buffer.

16. The transmitting device of claim 12, wherein the first size of the first portion of the buffer is larger than the second size of the first portion of the buffer.

17. The transmitting device of claim 12, wherein receiving the signaling indicating the second size of the first portion of the buffer occurs during or after a hibernate operation.

18. A non-transitory computer-readable medium storing code comprising instructions which, when executed by processing circuitry of a receiving device, cause the receiving device to:
allocate a first portion of a buffer to storing data received from a transmitting device;
transmit, to the transmitting device, signaling indicating a first size of the first portion of the buffer;
determine whether data stored at the first portion of the buffer satisfies a size threshold;
adjust a size of the first portion of the buffer from the first size to a second size in response to determining that the data stored at the first portion satisfies the size threshold;
and transmit, to the transmitting device, signaling indicating the second size of the first portion of the buffer in response to adjusting the size of the first portion of the buffer.

19. The non-transitory computer-readable medium of claim 18, wherein the instructions, when executed by the processing circuitry of the receiving device, further cause the receiving device to:
allocate a second portion of the buffer to storing data to be transmitted to the transmitting device.

20. The non-transitory computer-readable medium of claim 19, wherein the instructions, when executed by the processing circuitry of the receiving device, further cause the receiving device to:
determine whether data stored at the second portion of the buffer satisfies a second size threshold; and
adjust the size of the second portion of the buffer from a third size to a fourth size in response to determining that the data stored at the second portion satisfies the second size threshold.

21. The non-transitory computer-readable medium of claim 19, wherein the buffer comprises a third portion that is non-overlapping with the first portion and the second portion.

22. The non-transitory computer-readable medium of claim 21, wherein the instructions to adjust the size of the first portion, when executed by the processing circuitry of the receiving device, cause the receiving device to:
allocate at least some of the third portion of the buffer to storing the data received from the transmitting device.
